(19) United States
(12) Patent Application Publication
(10) Pub. No.: US 2008/0193832 A1
(43) Pub. Date: Aug. 14, 2008

(54) Device for Supplying Electric Power to a Motor Vehicle

(75) Inventors: Hugues Doffin, Creteil (FR); Roger Abadia, Neuilly-Plaisance (FR); Matthieu Treguier, Maisons Alfort (FR); Ertugrul Taspinar, Chatillon-Sur-Chalaronne (FR); Christophe Picod, Gif sur Yvette (FR)

Correspondence Address: MATTHEW R. JENKINS, ESQ., 2310 FAR HILLS BUILDING, DAYTON, OH, 45419, US

(73) Assignee: VALEO EQUIPEMENTS ELECTRIQUES MOTEUR, Creteil Cedex (FR)

(21) Appl. No.: 11/909,110

(22) PCT Filed: Mar. 23, 2006
(86) PCT No.: PCT/FR2006/000645

§ 371 Date: Sep. 19, 2007

(30) Foreign Application Priority Data
Mar. 25, 2005 (FR) 05 02974

(51) Int. Cl. H01M 6/00; F02N 11/06; H01G 9/00

(52) U.S. Cl. 429/122; 290/40 R; 361/500

(57) ABSTRACT

A connection box for connecting at least two electric power storage units. The two storage units are electrically connected by a connection box mounted at least on one of them, the box containing a circuit of connecting elements providing electrical connections to two separate distribution networks via terminals and to another connector.

### FIELD OF THE INVENTION

The invention relates to an electrical supply device for a motor vehicle grouping together several electrical energy storage units; it also concerns more particularly the structure of the connection means associated with these storage units, for the purpose of supplying several distinct electricity distribution networks.

### BACKGROUND OF THE INVENTION

In modern motor vehicles, the electrical energy requirements are continually increasing. The items of equipment functioning electrically are more and more numerous and the electric power necessary is greater and greater (several kilowatts). It is also desirable to be able to have available several supply voltages, for example 12 V and 24 V (or even more) in order to specifically supply such and such equipment. For example, though the lighting and small electric motors equipping the vehicle can be supplied at a voltage of 12 V, as in the past, other equipment (such as for example an alternator-starter) would have an advantage in benefiting from a higher supply voltage. The coexistence of two electrical distribution networks, or more, requires designing wiring where any connection error (on the occasion of a maintenance operation in particular) is impossible.

### SUMMARY OF THE INVENTION

The invention proposes to group together dedicated and secure connection means around a set of electrical energy storage units capable of meeting the requirements of the vehicle.

More precisely, the invention concerns an electrical supply device for a motor vehicle, characterised in that it comprises at least two electrical energy storage units and a connection box at least partially covering at least one such storage unit and containing a circuit of connection elements establishing electrical connections between on the one hand the terminals of the storage elements and on the other hand at least two distinct distribution networks, one of which is connected by two accessible terminals mounted on the box itself.

Thus a novel compact and rational functional assembly is defined, capable of delivering different specific voltages to several networks supplying different systems. It should be noted that one of the networks (typically the one that delivers the current at a voltage of 12 V) keeps its traditional connection whilst others (preferably all the others) are protected, not directly accessible to someone unskilled and connected to the connection box by dedicated sockets that are ‘foolproof’.

As mentioned previously, the connection box at least partially covers at least one such electrical energy storage unit. It can constitute a kind of protective cover covering one or all of these units. The latter can be installed in a container and in this case the connection box can form a kind of cover for the said container. The electrical energy storage units can be of different kinds. For example, it is possible to provide at least one electrochemical accumulator and another unit of a different kind such as for example a ‘supercapacitor’. According to another embodiment, at least two identical electrochemical accumulators will be provided, capable of being connected in series or in parallel. To this end, the connection box can contain a controlled switch, of the electronic or electromechanical type, making it possible to connect the two accumulators in series or in parallel. In a variant the switch is replaced by a circuit comprising at least two switches or a circuit comprising one switch and one breaker. By this simple means, it is therefore possible to have available a high voltage, for example 24 V, at the time of a starting phase and return to a normal lower voltage (12 V) when the thermal engine is functioning.

As indicated above, at least one aforementioned electrical energy storage unit may be a so-called supercapacitor component, that is to say in fact a capacitor with a very high capacitance. Such a component can be used in particular in relation to an energy recovery system or to supply an electrical energy peak when necessary, for example on starting.

Advantageously, the connection box can also contain a DC to DC converter.

Advantageously, the connection box comprises lugs for connection to the terminals of the said storage units. Such a lug comprises two rigid arms articulated on each other, allowing adaptation to storage units having terminals with any separation. These connection lugs, rigid and nevertheless adaptable, can constitute the means for mechanical mounting of the said box on top of the electrical energy storage units.

It should be noted that it is advantageous to dispose the connection box on top of the storage units grouped together side by side. It thus fulfils the additional role of a cover providing a certain amount of thermal protection and also protecting against leakages of dangerous substances or preventing the introduction of certain liquids. All the terminals of the storage units can be covered or at least made inaccessible by the connection box forming a cover, which prevents an inexperienced worker from having access to voltages other than the traditional low voltage (12 V).

### BRIEF DESCRIPTION OF THE DRAWINGS

The invention will be better understood and other advantages thereof will emerge more clearly in the light of the following description of an electrical supply device in accordance with its principle, given solely by way of example and made with reference to the accompanying drawings, in which:

FIG. 1 is a plan view of the electrical supply device comprising here two electrochemical accumulators placed side by side;

FIG. 2 is a view in elevation of the same device;

FIG. 3 is a detail view in perspective illustrating an electrical connection to the dedicated connection socket of the embodiment in FIGS. 1 and 2;

FIGS. 4 to 7 illustrate the steps of manufacturing the connection box depicted in FIGS. 1 and 2,

FIG. 8 illustrates another embodiment where the connection box forms the cover of a container containing a plurality of units known as ‘supercapacitors’;

FIG. 9 is a schematic view of a circuit of the electrical supply device for an example embodiment with a breaker and a switch.

### DESCRIPTION OF THE PREFERRED EMBODIMENTS

The electrical supply device 11 depicted comprises two electrical energy storage units 12a, 12b, which are placed side-by-side, and a connection box 14 at least partially covering these two storage units. In the example described, the two storage units are two electrochemical accumulators or electrochemical batteries with a nominal voltage of 12 V each. In a variant, one of the storage units can be such an electrochemical accumulator and the other can be a ‘supercapacitor’, that is to say with a higher capacitance (Ultracapacitance). A larger number of storage units can be envisaged.

The electrical supply device 11 is intended for example to form part of an arrangement for a motor vehicle comprising a reversible polyphase rotary electrical machine, such as an alternator-starter, and at least two electrical energy storage units 12a, 12b as described for example in the documents WO 03/088471 and WO 02/080334, to which reference should be made for more information.

This type of arrangement makes it possible to recover energy during braking and comprises two distribution networks, at least one switch or a circuit with two breakers and a direct current to direct current converter, referred to as a DC/DC converter, making it possible to convert voltages and to function at two different voltages.

For the record it should be stated that an alternator-starter is a reversible alternator making it possible firstly to transform mechanical energy into electrical energy when it is functioning in electrical generator mode in order in particular to recharge a battery and/or to supply the consumers of at least one onboard network of the motor vehicle and secondly to transform electrical energy into mechanical energy when it is functioning in electric motor mode, referred to as starter mode, in order in particular to start the internal combustion engine or thermal engine of the motor vehicle and, in one embodiment, to prevent the thermal engine stalling.

It should be noted that, in starter mode (functioning in electric motor mode), the arrangement makes it possible to supply the alternator-starter with a voltage higher than that in generator mode. This alternator-starter comprises current rectifying means referred as an inverter comprising for example transistors of the MOSFET type controlled by an electronic actuation and control unit as described for example in the documents FR A 2 745 444 and FR A 2 745 445.

This electronic actuation and control unit receives signals coming from sensors for the angular position of the rotor of the machine and also comprises controllers, referred to as drivers, which are power elements and which control the MOSFET-type transistors. These drivers, in one embodiment, belong to a power stage also comprising the MOSFET-type transistors of the inverter constituting an alternating to continuous reversible current electrical converter referred to as ‘AC/DC’ in electrical generator mode. In electric generator mode the MOSFET transistors of the inverter are controlled in two-state mode in order to control in full wave the windings of the stator of the machine or in a variant by a variable pulse width command.

The control elements belong to a stage with a lower power.

In the light of the aforementioned two documents WO 03/088471 and WO 02/080334, it can be seen that the two energy sources can consist of a battery and a high-value capacitor or ultracapacitor. In a variant, as described in FIG. 9 of the document WO 02/080334, it may be a case of two batteries with the presence of DC/DC converters and switches.

The electrical supply device 11 described below can form part, in another embodiment, of an arrangement for a motor vehicle comprising two batteries and an alternator-starter or an alternator and a starter, the starter or the alternator-starter being in starter mode adapted for example to be supplied at 24 V by means of two batteries in order to start the thermal engine of the motor vehicle, while the alternator or alternator-starter in generator mode is supplied at 12 V.

This is achieved by means of at least one switch or two breakers making it possible to connect the two batteries in series on starting up or in parallel with addition of the energy reserves of the two batteries.

The switch or breakers can be controlled by the actuation and control unit of the alternator-starter.

The two electrical energy storage units 12a, 12b are disposed so that their connection terminals 16 are as far away from each other as possible as shown. The connection box 14 is made from electrical insulating material, here from insulating plastics material. This box 14, according to one characteristic, covers at least the central part of the storage units 12a, 12b and in particular makes the said connection terminals 16 inaccessible or in any event difficult to access.

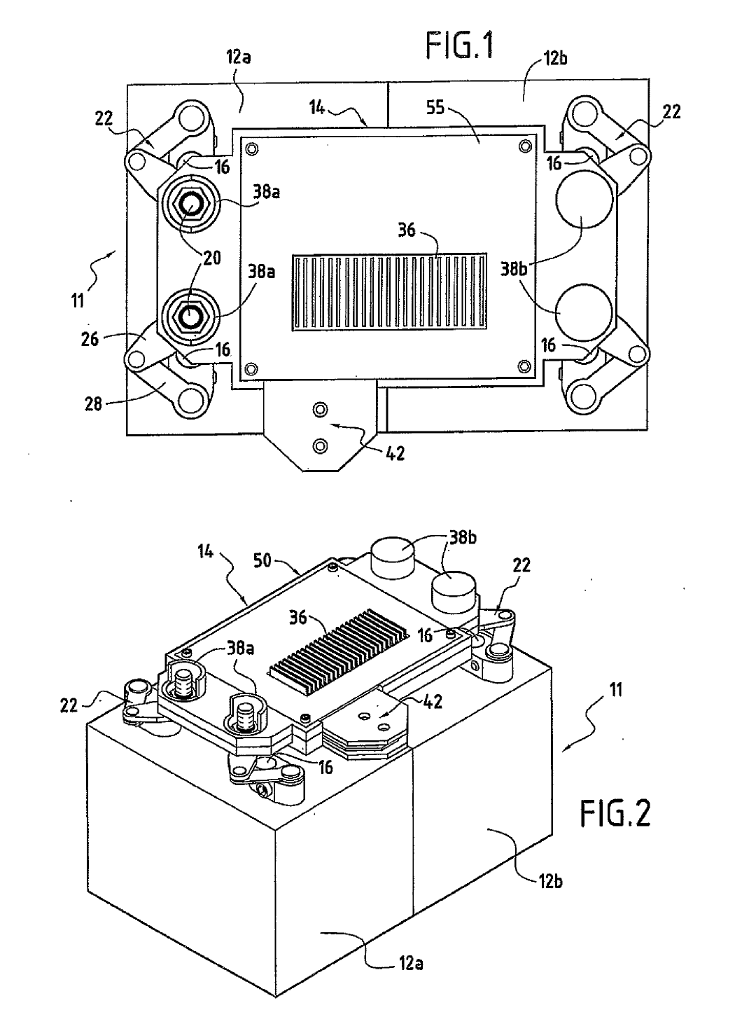

The connection box 14 contains a circuit comprising connection elements 18, here metal and flat, making it possible to establish electrical connections between on the one hand the terminals 16 of the storage elements and on the other hand two distinct distribution networks. One of the networks is connected to the two accessible terminals 20 mounted on the box itself. These terminals 20 are intended, as on a conventional battery, to be connected to earth and to a positive line connected to the onboard network of the vehicle. The other network is connected to two inaccessible terminals mounted on the box as described below. The connection box 14 comprises connection lugs 22 for connecting it to the terminals 16 of the said storage units. In FIG. 1 there can be seen four connection lugs 22 of this metal type. Each comprises two rigid arms 26, 28 articulated on each other, allowing an adaptation in length between a terminal provided on the connection box and the terminal 16 provided on the corresponding storage unit.

As can be seen in FIGS. 1 and 2, the arm 28 is mounted for articulation at one of its ends on an extension of a first electrically conductive lug (not referenced) mounted on the terminal 16.

This arm 28 is mounted for articulation at the other of its ends on the end of the arm 26 opposite to the end of this arm 26, which carries the terminal 20 or the inaccessible terminal (referenced 20′ in FIG. 9) mounted on the connection box 14.

These terminals 20, 20′ consist for example of a bolt, the head of which bears on the arm 26 with a hole in it for passage of the threaded part of the bolt.

The mounting therefore uses three elements, namely the first lug and the two arms 26, 28 articulated on each other, which form a pantograph between a terminal of an energy storage unit and a terminal of the box 14. This mounting allows a vertical offset between the terminals 16 and the accessible and inaccessible terminals of the box 14 as well as longitudinal and width-wise offsets.

Thus the same connection box can be used in relation to storage units with any different dimensions. Likewise, by virtue of the lugs 22, in another embodiment, the box 14 fully covers a storage unit 12a, 12b, or even the two storage units.

In the example, the metal connection elements 18, inserted in the connection box, establish the electrical connections between the connection lugs 22 and a controlled switch 30 (of the electromechanical or electronic type) integrated in the structure of the connection box 14. Such a switch makes it possible to connect the two electrical energy storage units in series or in parallel according to requirements. In a variant the switch is replaced by two controlled breakers.

The connection box 14 is connected to two distinct distribution networks, one of which is connected by two accessible terminals 20, provided on the box itself. The box comprises for this purpose two protrusions 38a, 38b made from plastics material surrounding the connection terminals of the lugs 22, on the box side, and which are either open or closed. When the protrusions are open (38a), it is possible to connect a distribution network (typically the 12 V network) directly to these terminals. On the other hand, according to one characteristic, no other connection is possible with the other terminals (20′—FIG. 9) of the other network since they are protected by closed protrusions 38b. Here the other network, which must not be accessible to an unskilled worker, is connected to a dedicated connection socket 42, foolproof and protected. This may be the case, for example, for the supply of an alternator-starter or an alternator. The socket 42 is connected to the switch by the connection elements 18.

Apart from the controlled breakers or the controlled switch 30, which is connected to the various flat connection elements 18 including in the box, the device can comprise at least one DC to DC converter 34 associated with the storage units as in the documents WO 03/088471 and WO 02/080334. Such electronic and/or electromechanical components are preferably mounted so as to be in thermal contact with a thermal dissipation radiator 36 emerging at the top surface of the box.

The radiator 36 is here metal and comprises fins as can be seen in FIGS. 1 to 3, 6 and 7. This radiator is for example made from aluminium.

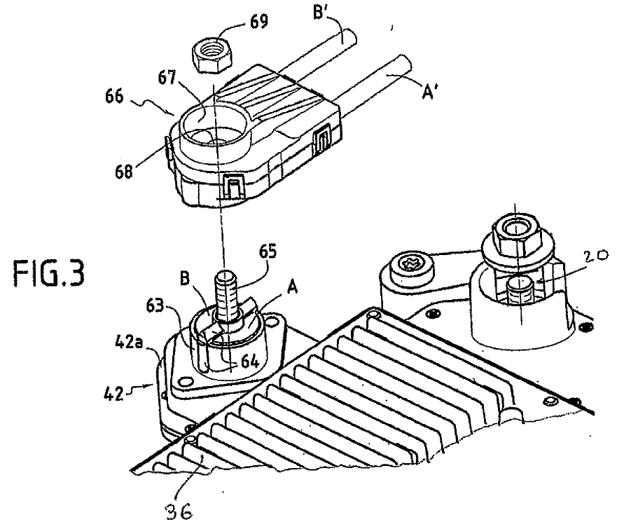

FIG. 3 shows an example of an electrical connection coming to be connected to the connection socket 42. This forms a base 42a on which a pedestal 63 made from insulating plastics material is mounted, enclosing two semi-annular metal terminals A and B separated by an insulating protecting bar 64 conformed so as to constitute a positive location device. A screw 65 insulated from the two terminals A and B projects at the centre of the pedestal. In addition, a connecting piece 66 to which there are connected two electric cables A′, B′ come in to be connected to the terminals A, B, respectively comprises a drilling 68 emerging at the bottom of a housing 67 able to receive a nut 69. The connecting piece 66 also comprises impressions (not visible) corresponding to the bar 64.

On assembly, the connecting piece is engaged on the pedestal so that the screw 65 projects at the centre of the housing 67.

Tightening the nut provides the two electrical connections. This arrangement is similar to that described in WO 02/060038 belonging to the applicant.

The terminal A corresponds to the low voltage level (earth). The terminal B corresponds to a positive voltage whose value V depends on the operating mode.

Typically V=12 volts in generator mode and V=12+X volts in starter mode. The connection box allows the voltage to be changed by modifying the combination of the storage units.

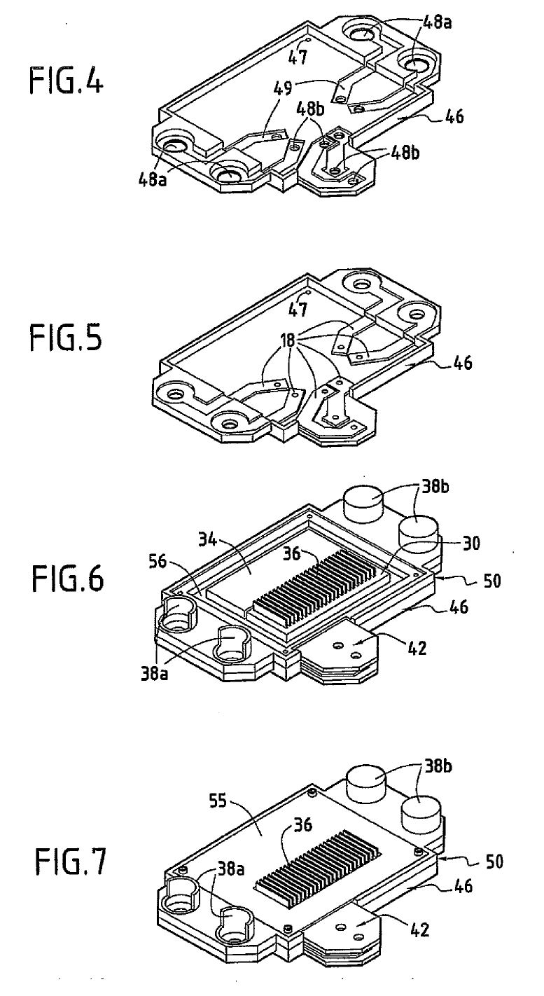

FIGS. 4 to 7 illustrate the various steps of manufacturing the said connection box 14. A bottom sole plate 46 made from insulating plastics material obtained by moulding. It comprises mounting holes 47, four holes 48a for the passage respectively of the accessible terminals 20 and the inaccessible terminals (20′—FIG. 9) covered by the protrusions 38b, holes 48b for the electrical connections 18 and impressions 49 reproducing the shapes of the connection elements 18 for housing these elements 18. This part is visible in FIG. 4. As shown in FIG. 5, the metal connection elements 18 are placed in the impressions 49 provided for this purpose. An intermediate part 50, made from plastics material, is moulded on and covers the connection elements 18 and the inaccessible connection terminals.

The elements 18 are thus sandwiched between the sole plate 46 and the intermediate part 50. In a variant this is produced in a single piece by insert moulding.

The end result is the configuration in FIG. 6, where the appearance of the open protrusions (38a) and the closed protrusions (38b) can be seen around the locations of the connection terminals of the said connection box. In addition, a hollow space 56 is provided for housing the electronic or electromechanical components such as the switch 30 and/or the converter 34. At least some of these components are cooled by the thermal dissipation radiator 36 that emerges from a cover 55 covering the whole central part of the box. This cover can be moulded on or assembled by screws.

In the light of the above the result is that the housing 14 can comprise at least the power stage of an alternator-starter or even the control stage of the alternator-starter, cables connecting the outputs of the phases of the alternator-starter to the box 14 containing the power stage and the control stage of the alternator-starter, for example of the three-phase type. In this case the pedestal 63 encloses three metal terminals separated from one another by means of three projecting bars 64. The radiator 36 makes it possible to cool these stages.

The power stage can be a circuit of the SMI type comprising a metal base, for example made from aluminium, pressed on the bottom face of the radiator 36, that is to say on the face of the radiator opposite to the face of this carrying the fins. This pressing is in one embodiment effected by screwing the base on the radiator or in a variant by bonding the base to the radiator.

A network of electric conductors, referred to as a lead frame, is bonded to the bottom face of the base by means of an electrically insulating adhesive.

The network of conductors is provided with surfaces receiving one or more electronic components, in particular the transistors of the MOSFET-type.

These conductors locally comprise electrically conductive struts. These struts, for example of the hollow cylindrical type, each bear on a connection element 18. The elements 18 are perforated at the holes 48b produced in the sole plate 46 and the struts are threaded internally.

Screws are provided to electrically and mechanically connect the elements 18 and the struts. The heads of the screws are housed in the holes 48b and bear on the internal face of the element 18 concerned. The threaded part of each screw passes through the hole in the element 18 concerned in order to be screwed into the associated strut. In a variant it is possible to weld the struts and the elements 18. The holes 47 serve for screwing the cover 55 with the sole plate 46 and the intermediate part 50. Screws can also serve for assembling the radiator 36 with the sole plate and the intermediate part.

The control circuit of the alternator-starter is in one embodiment a circuit of the PCB type placed alongside the power circuit of the SMI type. This circuit is fixed for example by screwing to the bottom face of the radiator 36.

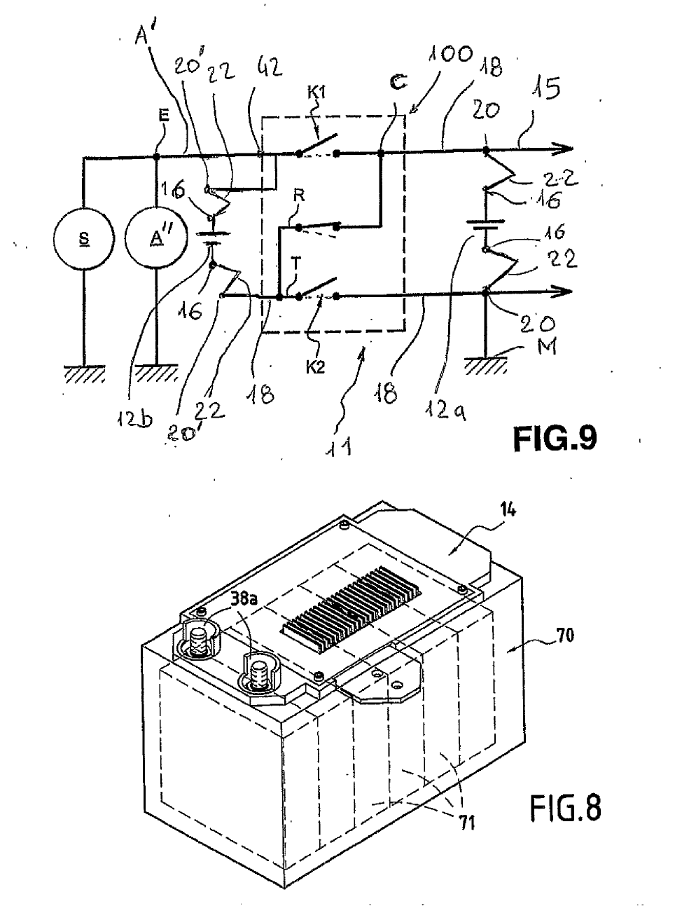

FIG. 8 illustrates a variant where the connection box 14 covers at least one storage unit and forms a kind of cover providing a certain degree of protection.

In this example, a receptacle 70 made from insulating plastics material shelters several storage units such as ‘supercapacitors’ 71. The storage units are connected together in series-parallel so as to present S units in series and P units in parallel in order to obtain the required voltage and capacitance. The connection box 14 is secured to the receptacle 70 and forms a kind of protective cover, for reasons of safety, since it is a case of ‘supercapacitors’.

The output terminals are the two terminals 38a as before. They deliver a voltage of 12 volts. In general terms, if the connection housing covers only one storage unit or some of them, this will as a priority be one of the ‘supercapacitors’.

As is clear from the drawings and the description, the electrical supply device for a motor vehicle according to the invention is compact and forms a unitary assembly that can be handled and transported with two accessible terminals 20 as for a normal electrochemical battery or accumulator with a reduction in the length of the electrical connection and simplification of these.

This compact arrangement thus makes it possible to reduce the connection inductances, in particular between the inverter and the DC to DC converter, or between the inverter and the ultracapacitor, which produce voltage ripples and resonance between the various components and earth shifts for the signals to be communicated between the various items of equipment.

Reducing the connection inductances also makes it possible to reduce the avalanche phenomenon at the inverter, a phenomenon well known to persons skilled in the art, which can produce thermal problems.

In addition, this compact arrangement avoids having the drawbacks of an exploded design of this type of electrical supply device, an exploded design that involves an increase in the number of electronic boxes in the vehicle and consequently an increase in the sealing and cooling requirements for each box, and many problems of wiring in the vehicle and strength of the connections.

Thus the integration and compactness of the storage units, the converters and the switch or breakers in the vehicle are improved, as well as their thermal and electrical behaviour during the functioning of the device.

Naturally the present invention is not limited to the example embodiments described since the present invention allows many applications.

Thus in a variant the box can comprise current, voltage or temperature sensors for the two energy storage sources, in particular in order to detect voltage drops or in general terms to monitor the state of these energy sources.

An actuator for disconnecting the energy storage sources in the event of collision can be integrated in the box.

This box can comprise at least one supplementary terminal connected to electronic components in order to dialogue and communicate for example with the motor vehicle engine control. Thus the box can comprise the voltage regulator for the rotary electrical machine, such as an alternator-starter.

The electrochemical accumulators can be batteries of any type, for example lead, NiMH (nickel metal hybride) or lithium.

The circuits for connecting the energy storage sources in series and parallel can have varied forms since everything is grouped together at the box.

Thus this circuit can be of the type in FIGS. 4 and 5 of the document EP A 1360090. This circuit can also comprise a controlled switch and a controlled breaker.

In a variant, as visible in FIG. 9, the device according to the invention can form part of a circuit comprising an electromechanical unit including an alternator A″ and a starter S connected in parallel whilst being connected by a first terminal to earth and by a second terminal E. In a variant the electromechanical unit comprises an alternator-starter replacing the alternator A″ and the starter S. In a known manner the alternator A″ comprises a bridge rectifier and a voltage regulator, a cable A′ connecting the terminal 42 to the terminal E. The terminal 42 is then dedicated to the supply of a starter and an alternator or to the supply of an alternator-starter.

The device comprises a breaker K1 and a switch K2.

The switch K2 and the breaker K1 form a switching unit 100 integrated in the box 14 of FIG. 2.

In this FIG. 9 the switch K2 is in position R, whilst the breaker K1 is open.

In this configuration the two energy storage units 12a, 12b are in series.

In the second position (K1 and K2 shown in dotted lines) the switch K2 is in position T and the breaker K1 is closed so that the two sources 12a, 12b are connected in parallel; the point C being at the potential of the terminal E. The switching unit 100 comprises in one embodiment electronic components controlled by hard-wired control. The reference 15 represents the positive supply line of the onboard network of the vehicle and M the earth.

What is claimed:

1. An electrical supply device for a motor vehicle, said electrical supply device comprising:
at least two electrical energy storage units and a connection box at least partially covering at least one such electrical energy storage unit and enclosing a connection element circuit—establishing electrical connections between on the one hand terminals of said electrical energy storage units and on the other hand at least two distinct distribution networks, one of which is connected by two accessible terminals mounted on said connection box.

2. The electrical supply device according to claim 1, wherein said connection box—comprises lugs for connection to the terminals of said electrical energy storage units, in that such lugs each comprise two rigid arms articulated on each other, allowing an adaptation to storage units having terminals of any separation.

3. The electrical supply device according to claim 2, wherein said lugs for connection comprise said rigid arms which constitute the means of mechanical mounting of said connection box, the latter being carried by said electrical energy storage units.

4. The electrical supply device according to claim 1, wherein said connection box is made from insulating plastics material and in that said connection element circuits are flat conductors inserted in said plastics material.

5. The electrical supply device according to claim 1, wherein said connection box encloses a controlled switch able to connect said at least two electrical energy storage units in series or in parallel.

6. The electrical supply device according to claim 1, wherein said connection box encloses a DC to DC converter.

7. The electrical supply device according to claim 1, wherein said connection box integrates at least the power stage of an alternator-starter.

8. The electrical supply device according to claim 1, which comprises a heat dissipation radiator, in thermal contact with components included in said connection box.

9. The electrical supply device according to claim 1, wherein said connection box comprises a dedicated connection socket for the protected connection of another current distribution network.

10. The electrical supply device according to claim 9, wherein said current distribution network is specifically dedicated to the supply of a starter and an alternator or an alternator-starter.

11. The electrical supply device according to claim 1, wherein at least one of said electrical energy storage units is an electrochemical accumulator.

12. The electrical supply device according to claim 1, wherein at least one of said electrical energy storage units is a component known as a supercapacitor.

13. The electrical supply device according to claim 1, wherein said electrical energy storage units are installed in a receptacle and in that said connection box is secured to said receptacle.

14. An electrical supply device for a motor vehicle, said electrical supply device comprising:
a plurality of electrical energy storage units;
a connection housing at least partially covering at least one of said plurality of electrical energy storage units;
said connection housing comprising a connection element circuit for electrically connecting at least one terminal of each of said plurality of electrical energy storage units and a plurality of distinct distribution networks, with each of said plurality of distinct distribution networks requiring a different voltage.

15. The electrical supply device as recited in claim 14 wherein each of said plurality of electrical energy storage units comprising a pair of terminals, at least one pair of terminals for at least one of said plurality of electrical energy storage units to said connection element circuit being accessible terminals mounted on said connection housing.

16. The electrical supply device according to claim 14, wherein said connection housing comprises lugs for connection to the terminals of said storage units, in that such lugs each comprise two rigid arms articulated on each other, allowing an adaptation to storage units having terminals of any separation.

17. The electrical supply device according to claim 14, wherein said connection housing encloses a controlled switch able to connect said plurality of electrical energy storage units in series or in parallel.

18. The electrical supply device according to claim 14, wherein said connection box encloses a DC to DC converter.

19. The electrical supply device according to claim 14, wherein said connection housing comprises a dedicated connection socket for the protected connection of another current distribution network.

20. The electrical supply device according to claim 19, wherein said current distribution network is specifically dedicated to the supply of a starter and an alternator or an alternator-starter.
